(19) United States
(12) Patent Application Publication
(10) Pub. No.: US 2007/0109220 A1
(43) Pub. Date: May 17, 2007

(54) Plasma display module

(76) Inventor: Kwang-jin Jeong, Suwon-si (KR)

Correspondence Address: KNOBBE MARTENS OLSON & BEAR LLP, 2040 MAIN STREET, FOURTEENTH FLOOR, IRVINE, CA, 92614, US

(21) Appl. No.: 11/591,947

(22) Filed: Nov. 2, 2006

(30) Foreign Application Priority Data
Nov. 12, 2005 (KR) 10-2005-0108299

(51) Int. Cl. G09G 3/28

(52) U.S. Cl. 345/60

(57) ABSTRACT

A plasma display module is disclosed. In one embodiment, the display module includes i) a chassis base that has a bent portion bent with respect to at least one edge of the chassis base, ii) a plasma display panel that is supported in front of the chassis base and displays images, circuit boards that are supported in rear of the chassis base and drive the plasma display panel, and iii) a plurality of driving cables electrically coupling the plasma display panel to the circuit boards. At least one of the driving cables includes a first end connected to the plasma display panel and a second end that extends from the first end toward the chassis base and is pressed down on and contacts the bent portion. A clip which presses the second end down on the bent portion and grounds the second end to the bent portion is fit on the bent portion. Accordingly, the number of circuit boards required to drive the plasma display panel decreases, thereby reducing the manufacturing costs for the plasma display module.

### CROSS-REFERENCE TO RELATED PATENT APPLICATION

This application claims priority to and the benefit of Korean Patent Application No. 10-2005-0108299, filed on Nov. 12, 2005, which is hereby incorporated by reference for all purposes as if fully set forth herein.

### BACKGROUND OF THE INVENTION

1. Field of the Invention

The present invention relates to a plasma display module, and more particularly, to a plasma display module having circuit boards whose number required to display images is reduced.

2. Description of the Related Art

Plasma display modules, which are flat display modules for displaying images using a gas discharge phenomenon, provide various advantages, such as a high display capacity, a high luminance, a high contrast, reduced afterimages, and a wide-range viewing angle. Plasma display modules have attracted considerable attention as next-generation flat display modules which can replace conventional cathode ray tube (CRT), because they can be thin and large in size compared with other flat display panels.

FIG. 1 is a diagram showing a structure of a conventional plasma display module. The plasma display module includes a plasma display panel 30 having a first panel 10 and a second panel 20, and an X driver, a Y driver, and an address driver that apply driving signals to the plasma display panel 30. A plurality of electrodes X, Y, and A that contribute to display discharge are arranged on the plasma display panel 30. For example, a plurality of sustain electrodes X and a plurality of scan electrodes Y extending parallel to each other are arranged on the first panel 10. A plurality of address electrodes A crossing the electrodes X and Y are arranged on the second panel 20. The sustain electrodes X and the scan electrodes Y are electrically coupled to the X driver and the Y driver, respectively. The address electrodes A are electrically coupled to the address driver to receive a driving signal from the address driver. The sustain electrodes X and the scan electrodes Y alternate each other and make pairs. Display discharge occurs between a pair of a sustain electrode X and a scan electrode Y, whereby an image is obtained. A portion where a pair of electrodes X and Y crosses an address electrode A is defined as a sub-pixel 31. Three sub-pixels emitting different colors, namely, R, G, and B sub-pixels 31, constitute a pixel.

The plasma display panel 30 having this structure is driven by repeating a driving period including a reset period, an address period, and a sustain period. During the reset period, the charge states of all sub-pixels 31 become uniform. During the address period, address discharge occurs in selected sub-pixels 31 by applying sequentially-controlled address signals to the address electrodes A. Wall charges are accumulated in the sub-pixels 31 that have undergone address discharge, and a predetermined wall voltage is formed. During the sustain period, predetermined alternating current (AC) pulses in which a sustain discharge voltage alternate with a ground voltage are applied to all of the sustain electrodes X and the scan electrodes Y. In the sub-pixels 31 in which the wall voltage is formed by address discharge, a voltage equal to or higher than a discharge start voltage is formed by an overlap of the wall voltage with a sustain discharge voltage, whereby display discharge is generated.

As described above, in the conventional plasma display module, AC pulses should be applied to the sustain electrodes X and the scan electrodes Y, so that both the X driver and the Y driver should be provided to apply driving signals to the sustain electrodes X and the scan electrodes Y. However, each of the drivers is a high-priced circuit board on which a plurality of circuits are mounted, resulting in an increase in the manufacturing costs for image display devices.

The circuit board as each driver generates high heat according to its operation. If this high heat is not rapidly removed, the accumulated heat degrades the circuits on the circuit board, hindering smooth operations of the circuits. Hence, a special heat conduction structure is required to prevent heat from accumulating in a narrow case on which a plurality of circuit boards are integrated with one another. Furthermore, a circuit board that generates a periodical electrical signal makes noise or a vibration, and when the noise and vibration go outside, the quality of display is degraded. Thus, in a conventional plasma display module provided with a plurality of circuit boards, a special vibration damping structure for blocking external noise is required.

### SUMMARY OF CERTAIN INVENTIVE ASPECTS

One aspect of the present invention provides a plasma display module having circuit boards where a certain circuit boards are [0009]Another aspect of the invention provides a plasma display module, comprising: a chassis base configured to support a plasma display panel and at least one driving cable, having first and second ends, wherein the first end is electrically connected to the plasma display panel, and wherein the second end is grounded via a portion of the chassis base.

Another aspect of the present invention provides a plasma display module comprising: a chassis base providing a grounding area and having a bent portion bent with respect to at least one edge of the chassis base, a plasma display panel supported in front of the chassis base, displaying images, circuit boards supported in rear of the chassis base, driving the plasma display panel and a plurality of driving cables electrically coupling the plasma display panel to the circuit boards, wherein at least one of the driving cables includes a first end connected to the plasma display panel and a second end that extends from the first end toward the chassis base and is pressed down on and contacts the bent portion, and a clip which presses the second end down on the bent portion and grounds the second end to the bent portion is fit on the bent portion.

Another aspect of the present invention provides a plasma display module comprising: a chassis base providing a grounding area and having a bent portion bent with respect to at least one edge of the chassis base, a plasma display panel supported in front of the chassis base and displaying images, the panel comprising a plurality of pairs of scan electrodes and sustain electrodes that cause display discharge, each pair including a scan electrode and a sustain electrode, and the first ends of the driving cables are electrically coupled to the sustain electrodes, circuit boards supported in rear of the chassis base, driving the plasma display panel and a plurality of driving cables electrically coupling the plasma display panel to the circuit boards and applying driving signals generated by the circuit boards to the electrodes of the plasma display panel, wherein each of the driving cables includes a first end electrically connected to the sustain electrodes and a second end that extends from the first end toward the chassis base and is pressed down on and contacts the bent portion, and a clip which presses the second end down on the bent portion and grounds the second end to the bent portion is fit on the bent portion.

In one embodiment, the at least one driving cable is a sustain electrode driving cable, wherein

### BRIEF DESCRIPTION OF THE DRAWINGS

Embodiments of the invention will be described with reference to the drawings.

FIG. 1 is a diagram illustrating a structure of a conventional plasma display module.

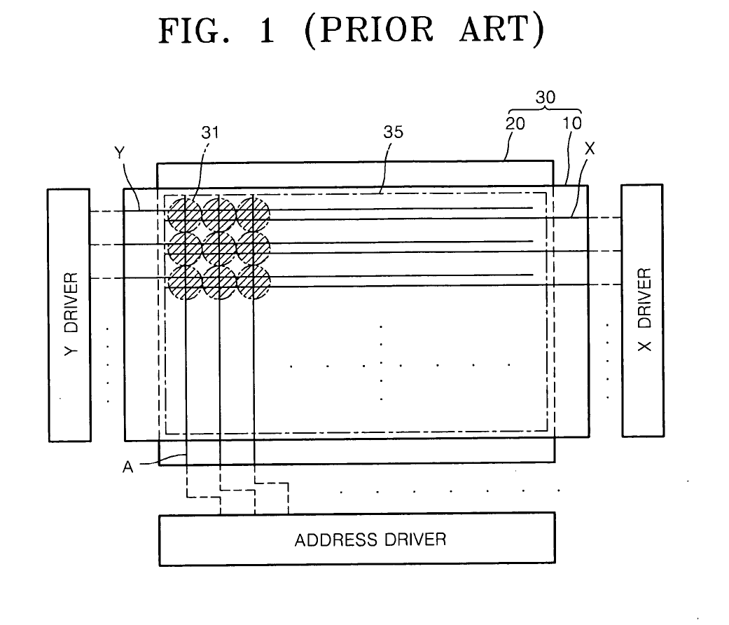

FIG. 2 is a diagram illustrating a structure of a plasma display module according to an embodiment of the present invention.

FIG. 3 is an exploded perspective view of the plasma display module of FIG. 2.

FIG. 4 is an exploded perspective view of a grounding structure shown in FIG. 3.

FIG. 5 is a cross-section taken along line V-V of FIG. 4.

FIG. 6 is a magnified cross-section of a grounded portion shown in FIG. 5.

### DETAILED DESCRIPTION OF CERTAIN INVENTIVE EMBODIMENTS

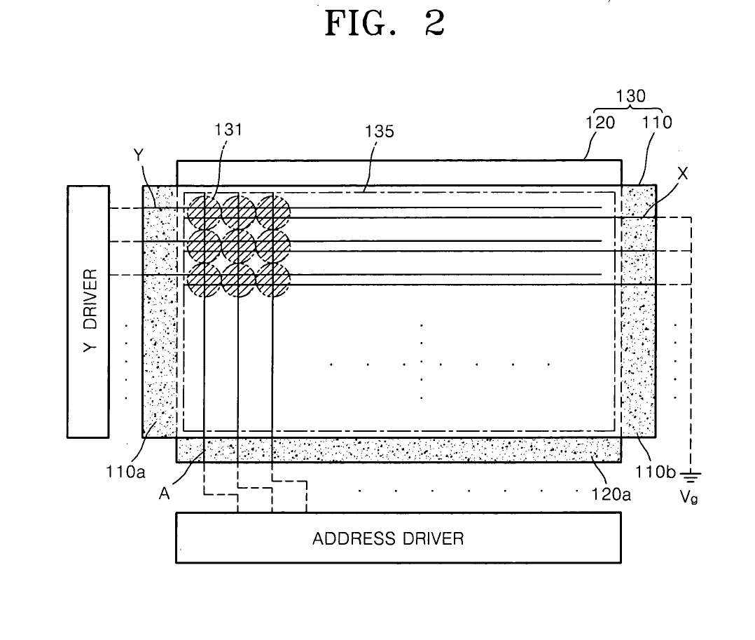

FIG. 2 is a diagram illustrating a structure of a plasma display module according to an embodiment of the present invention. Referring to FIG. 2, the plasma display module includes a plasma display panel 130 which forms an image using display discharge, and drivers electrically connected to the plasma display panel 130 to drive the same. The plasma display panel 130 includes a first panel 110 and a second panel 120 which face each other. A plurality of sub-pixels 131 are arranged horizontally and vertically in a space 135 where the first and second panels 110 and 120 overlap with each other. Each of the sub-pixels 131 may be defined as a space where a sustain electrode X and a scan electrode Y extending substantially parallel to each other cross an address electrode A. Three sub-pixels emitting different colors, namely, R, G, and B sub-pixels 131, may constitute a pixel.

The sustain electrodes X and the scan electrodes Y alternate to form pairs. A predetermined image is formed by display discharge occurring in each pair of a sustain electrode X and a scan electrode Y. The address electrodes A, crossing the sustain and scan electrodes X and Y substantially parallel to each other, perform address discharge. Address discharge denotes auxiliary discharge that occurs between the scan electrodes Y and the address electrodes A and facilitates display discharge between the sustain and scan electrodes X and Y. Although not shown in FIG. 2, barrier ribs may be formed between adjacent sub-pixels 131 and define the sub-pixels 131 to obtain independent discharge spaces.

Terminal areas 110a, 110b, and 120a where the electrodes X, Y, an A are electrically connected to the drivers occur are formed on the outskirts of the space 135 in which the plurality of sub-pixels 131 are arranged. In one embodiment, the scan electrodes Y and the Y driver are electrically coupled to each other on the terminal area 100a located at the left edge of the first panel 110. In this embodiment, the terminal area 110b, located at the right edge of the first panel 110, used to ground the sustain electrodes X. In this embodiment, the address electrodes A and the A driver are electrically coupled to each other on the terminal area 120a located at the bottom edge of the second panel 120. The scan electrodes Y are electrically connected to the Y driver and receives a controlled signal. The address electrodes A are electrically connected to the address driver and receives a driving signal. In one embodiment, the sustain electrodes X are grounded to a ground line, and a ground voltage Vg with a certain level is applied to all of the sustain electrodes X. Accordingly, in contrast with a conventional plasma display panel, a special X driver for applying a driving signal (e.g., non-ground voltage) to the sustain electrodes X is not required.

In a conventional plasma display module, an alternating pulse in which a sustain discharge voltage and a ground voltage alternate is applied to the sustain and scan electrodes X and Y during a sustain period when an image is displayed. However, in one embodiment of the present invention, an alternating pulse is applied to only the scan electrodes Y, and the ground voltage Vg is applied to the sustain electrodes X. For example, an AC voltage in which a positive sustain discharge voltage and a ground voltage alternate is applied to the sustain and scan electrodes X and Y in a conventional plasma display module. In contrast, in a plasma display module according to one embodiment of the present invention, an alternating pulse in which a positive sustain discharge voltage and a negative sustain discharge voltage alternate is applied to the scan electrodes Y and a ground voltage Vg with a certain level is applied to the sustain electrodes X. In this way, a sustain discharge voltage with the same level as that in a conventional art may be applied between the sustain and scan electrodes X and Y in the plasma display module according to one embodiment of the present invention. In another embodiment, the ground voltage Vg may be applied to the scan electrodes Y or address electrodes A. In this embodiment, one end of the corresponding driving cables may be grounded to the chassis base. Furthermore, a corresponding driver for the Y or A electrodes is not needed.

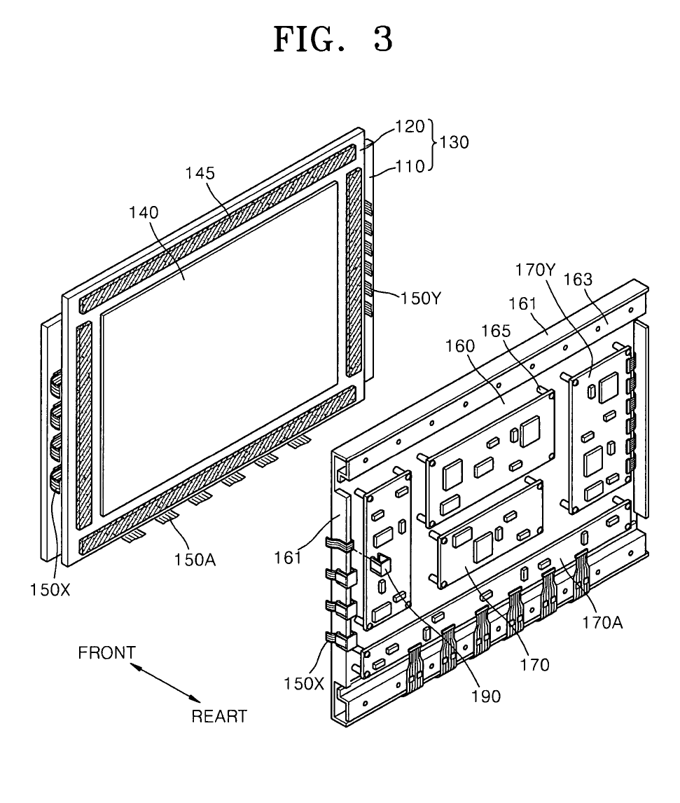

FIG. 3 is an exploded perspective view of the plasma display module of FIG. 2. Referring to FIG. 3, the plasma display module includes the plasma display panel 130 on which images are displayed, a chassis base 160 installed at the rear of the plasma display panel 130 and supporting the plasma display panel 130, and a heat conduction sheet 140 interposed between the plasma display panel 130 and the chassis base 160.

As described above with reference to FIG. 2, the plasma display panel 130 includes the first and second panels 110 and 120 on which a plurality of electrodes X, Y, and A that cause discharge are arranged. The plasma display panel 130 serves as an image display unit. A plurality of driving cables 150X, 150Y, and 150A extend rearwards from edges of the plasma display panel 130, and transmit controlled driving signals to the electrodes X, Y, and A. The driving cables 150X denotes X driving cables that transmit a ground voltage to the sustain electrodes X, the driving cables 150Y denote Y driving cables that are coupled to the scan electrodes Y to transmit a controlled driving signal to the scan electrodes Y. Also, the driving cables 150A denote address driving cables that are coupled to the address electrodes A to transmit an address signal to the address electrodes Y. In one embodiment, each of the driving cables 150X, 150Y, and 150A include a plurality of conductive patterns. The conductive patterns of the driving cables 150X, 150Y, and 150A are coupled to the electrodes X, Y, and A.

The plasma display panel 130 may be coupled to the chassis base 160 by a dual adhesive tape 145, with the heat conduction sheet 140 interposed between the plasma display panel 130 and the chassis base 160. The dual adhesive tape 145 is attached along the edges of heat conduction sheet 140. Since the heat conduction sheet 140 exists between the plasma display panel 130 and the chassis base 160, it transmits the heat generated by the plasma display panel 130 to the chassis base 160.

The chassis base 160 also serves as a heat conduction plate for the plasma display panel 130 and functions as a ground connection area because of its wide area. To achieve this, the chassis base 160 may be formed of metal having high heat and electricity conductivities, such as, aluminum Al. Because the chassis base 160 also serves as a support for the plasma display panel 130 at its front side and circuit boards 170 at its rear side, the chassis base 160 may have vertically bent portions 161 along its edges so as to reinforce the support intensity. In addition, special reinforcing members 163 may be installed on the rear surface of the chassis base 160. In one embodiment, clips 190 grip the bent portion 161 on one edge of the chassis base 160, that is, the left edge thereof. The clips 190, which are used to closely attach the X driving cables 150X to the chassis base 160, will be described later.

The plurality of circuit boards 170 driving the plasma display panel 130 are installed on the rear surface of the chassis base 160. Some of the circuit boards 170 serve as drivers for applying controlled driving signals to the electrodes X, Y, and A of the plasma display panel 130. For example, a circuit board 170Y to which the Y driving cables 150Y are coupled corresponds to the Y driver shown in FIG. 2, and a circuit board 170A to which the address driving cables 150A are coupled corresponds to the address driver shown in FIG. 2. The circuit boards 170Y and 170A may be replaced by a single circuit board to which both the driving cables 150Y and 150A are coupled. Alternatively, the circuit boards 170Y and 170A may be replaced by at least two circuit boards electrically coupled to each other. In addition to the circuit boards 170Y and 170A, the circuit boards 170 may further include an SMPS circuit board, a logic circuit board, etc., that execute different functions.

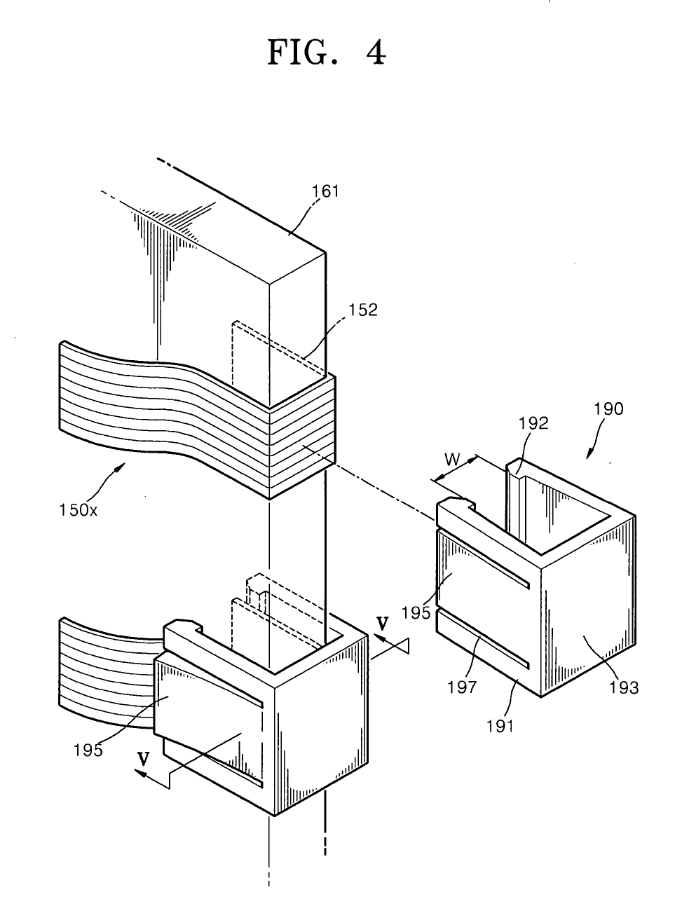

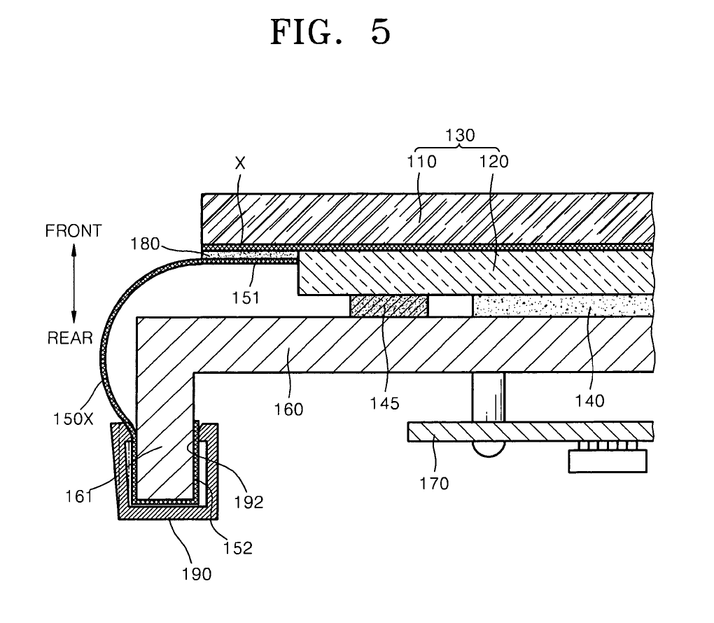

In one embodiment, the X driving cables 150X are not coupled to any of the circuit boards 170 and instead grounded to the chassis base 160. FIG. 4 is a perspective view of a grounding structure of each of the X driving cables 150X shown in FIG. 3. FIG. 5 is a cross-section taken along line V-V of FIG. 4. Referring to FIGS. 4 and 5, a first end 151 of the X driving cable 150X is electrically coupled to a sustain electrode X of the first panel 110. An anisotropic conductive adhesive 180 is interposed between the sustain electrode X and the X driving cable 150X. The anisotropic conductive adhesive 180 is a conductive material that applies conductivity only in a direction in which the conductive material is pressed down. In one embodiment, the X driving cable 150X is pressed down on the sustain electrode X with the anisotropic conductive adhesive 180 interposed therebetween, so that the X driving cable 150X and the sustain electrode X are electrically coupled to each other. A junction of the sustain electrode X and the X driving cable 150X may be sealed with a silicon sealant (not shown), for example, to insulate and protect the junction from external environments.

The first end 151 of the X driving cable 150X may extend toward the rear surface of the plasma display panel 130 while forming a round curve. In one embodiment, a second end 152 of the driving cable 150X is pressed down on and contacts the chassis base 160 by, for example, a clip 190 that grips a bent portion 161 of the chassis base 160. In other words, the clip 190 presses the second end 152 of the driving cable 150X down on the chassis base 160. The second end 152 of the driving cable 150X may be squeezed between the clip 190 and the chassis base 160 and fixed to the bent portion 161. In another embodiment, the second end 152 of the driving cable 150X may be coupled to the chassis base 160 via other fixing member, for example, a clamp or an adhesive tape. In still another embodiment, the second end 152 of the driving cable 150X may be grounded to the chassis base 160 without the use of a fixing member. In this embodiment, the second end 152 may be directly connected to the chassis base 160 by, for example, inserting the end 152 to a hole (not shown) of the chassis base 160.

In one embodiment, the clip 190 has a shape of nearly “c” to surround the bent portion 161. The clip 190 may include two sidewalls 191 separated from each other having an aperture with a width W through which the chassis base 160 enters between the two sidewalls, and contacting both lateral surfaces of the chassis base 160, and a coupling portion 193 coupling the sidewalls 191 to each other so that the sidewalls 191 can be elastically biased in directions facing each other so as to contact the lateral surfaces of the chassis base 160 with a predetermined pressure. The sidewall 191 of the clip 190 which starts contacting the X driving cable 150X may have two slits 197 formed in a direction in which the X driving cable 150X extends. The slits 197 are separated from each other by a gap corresponding to at least the width of the X driving cable 150X. A cutout portion 195 cut out of the main body of the clip 190 by the slits 197 guides the X driving cable 150X by pushing the X driving cable 150X toward the chassis base 160. Due to the formation of the slits 197 in the clip 190, the cutout portion 195 of the clip 190 starting the contact with the X driving cable 150X can be deformed within a predetermined range and thus can gently deform the X driving cable 150X. When the X driving cable 150X is sharply deformed by the clip 190, edges of the X driving cable 150X and the clip 190 may interfere with each other, and thus the X driving cable 150X may be worn away. In addition, a bending resistance of the X driving cable 150X causes it take the clip 190 long time and much effort to grip the X driving cable 150X.

Pressing protrusions 192 having wedge shapes protrude from the sidewalls 191 of the clip 190 toward the chassis base 160. The pressing protrusions 192 of the clip 190 press down on and contact the chassis base 160 or the driving cable 150X. The pressing protrusions 192 firmly fixes the clip 190 to prevent the clip 190 fit on the chassis base 160 from being detached from the chassis base 160 by unexpected impacts.

When the clip 190 is in a free state, that is, not influenced by an external force, the gap W of the clip 190 is narrow. When the clip 190 is pressed by the bent portion 161 of the chassis base 160, the gap W of the clip 190 is open wider to receive the bent portion 161. In other words, the clip 190 may be elastic. The clip 190 fit on the bent portion 161 is pressed down on and contacts the lateral surfaces of the bent portion 161 by its own elasticity, so that the clip 190 is firmly fixed to the bent portion 161. If the clip 190 is formed of a material providing predetermined elasticity, various materials may be used without restrictions. In one embodiment, when considering the fact that the clip 190 is exposed, the clip 190 is formed of an insulative material. For example, the clip 190 may be formed of plastic for convenience of processing.

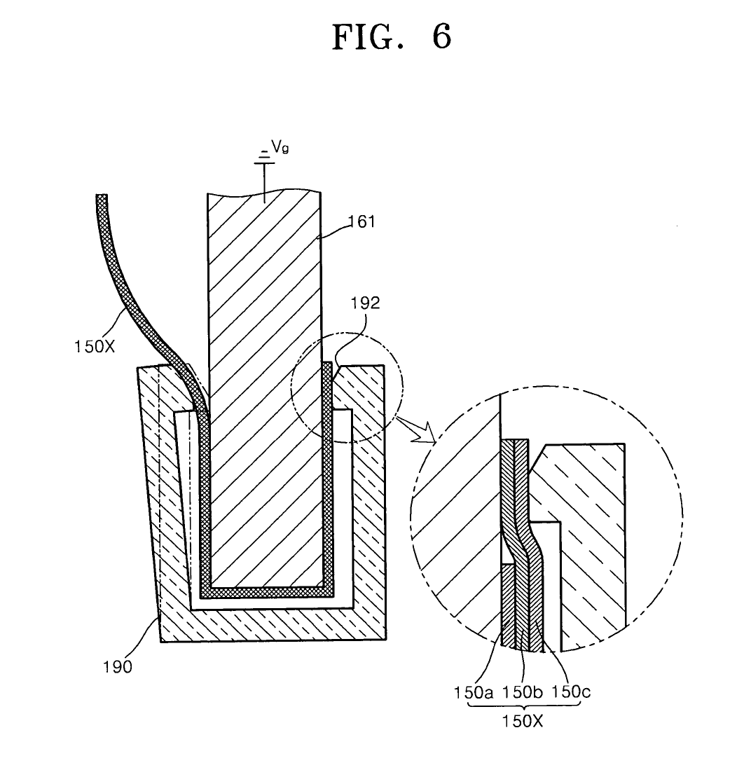

FIG. 6 is a magnified cross-section of a grounded portion of the driving cable 150X shown in FIG. 5. Referring to FIG. 6, the pressing protrusions 192 protrude from the sidewalls of the clip 190 toward the chassis base 160 and are pressed down on and contact the bent portion 161 with a predetermined pressure, so that the bent portion 161 is firmly fixed to the chassis base 160. The X driving cable 150X includes a conductive pattern layer 150b in which a ground voltage Vg is maintained and cover films 150a and 150c which cover both surfaces of the conductive pattern layer 150b to insulate the conductive pattern layer 150b from external environments. To attach the cover films 150a and 150c to the both surfaces of the conductive pattern layer 150b, adhesive layers (not shown) may be formed between the conductive pattern layer 150b and the cover film 150a and between the conductive pattern layer 150b and the cover film 150c. A portion of the cover film 150a corresponding to a portion of the driving cable 150X that contacts the chassis base 160 by the clip 190 is removed off so that the exposed conductive pattern layer 150b electrically contacts the chassis base 160. Alternatively, a dedicated driving cable having no insulation elements, such as, cover films, at a portion where the conductive pattern layer 150b faces the chassis base 160 may be used.

Compared with a convention plasma display module, a plasma display module according to one embodiment of the present invention can drive a plasma display panel using a reduced number of circuit boards. Thus, an image display apparatus including the plasma display module can be manufactured at drastically reduced costs. Furthermore, the costs and processes required to design means for conducting heat generated by circuit boards or damping vibrations generated by the circuit boards can be saved.

While the above description has pointed out novel features of the invention as applied to various embodiments, the skilled person will understand that various omissions, substitutions, and changes in the form and details of the device or process illustrated may be made without departing from the scope of the invention. Therefore, the scope of the invention is defined by the appended claims rather than by the foregoing description. All variations coming within the meaning and range of equivalency of the claims are embraced within their scope.

What is claimed is:

1. A plasma display module, comprising:
a chassis base having a bent portion that is bent with respect to at least one edge of the chassis base;
a plasma display panel, supported by a first surface of the chassis base, configured to display images;
a plurality of circuit boards, located on a second surface of the chassis base, configured to drive the plasma display panel, wherein the second surface opposes the first surface; and
a plurality of driving cables configured to electrically couple the plasma display panel to the circuit boards,
wherein:
at least one of the driving cables includes a first end connected to the plasma display panel and a second end that extends from the first end toward the chassis base and is pressed down on and contacts the bent portion; and
a clip which presses the second end down on the bent portion and grounds the second end to the bent portion is fit on the bent portion.

2. The plasma display module of claim 1, wherein the second end of the driving cable is located to surround at least one portion of the bent portion, and the clip is forcibly fit on the bent portion with the second end interposed between the clip and the bent portion.

3. The plasma display module of claim 1, wherein the clip comprises:
two sidewalls separated from each other having an aperture with a predetermined width through which the chassis base enters between the two sidewalls; and
a coupling portion coupling the sidewalls to each other so that the sidewalls can be elastically biased in directions facing each other.

4. The plasma display module of claim 3, further comprising pressing protrusions extending from the sidewalls toward the chassis base and contacting the chassis base or the driving cable with a predetermined pressure.

5. The plasma display module of claim 3, wherein two slits cut in a direction in which the driving cable extends are formed in one of the sidewalls of the clip that starts contacting the driving cable, and the slits are separated from each other by a gap corresponding to at least the width of the driving cable.

6. The plasma display module of claim 5, wherein the slits define a cutout portion therebetween configured to be at least partially deformed in a direction so as to facilitate fixing the second end of the cable to the chassis base.

7. The plasma display module of claim 6, wherein the cutout portion of the clip contacts the driving cable with a predetermined pressure and pushes the driving cable toward the chassis base.

8. The plasma display module of claim 1, further comprising an anisotropic conductive adhesive configured to conductively couple the first end of the driving cable to the electrodes of the plasma display panel.

9. The plasma display module of claim 1, wherein the driving cable comprises:
a conductive pattern layer conducting an electrical signal; and
cover films covering both lateral surfaces of the conductive pattern layer, wherein a portion of the cover film closer to the chassis base corresponding to at least a portion of the second end is removed, and the exposed portion of the conductive pattern layer is grounded to the chassis base.

10. The plasma display module of claim 1, wherein the plasma display panel includes a plurality of pairs of scan electrodes and sustain electrodes configured to generate a display discharge, each pair including a scan electrode and a sustain electrode, and the first ends of the driving cables are electrically coupled to the sustain electrodes.

11. The plasma display module of claim 10, wherein the plasma display panel is configured to be driven by repeating a driving period including a reset period, an address period, and a sustain period, and a ground voltage is applied to the sustain electrodes during the driving period.

12. A plasma display module, comprising:
a chassis base having a bent portion that is bent with respect to at least one edge of the chassis base;
a plasma display panel supported by a first surface of the chassis base and configured to display images, the panel comprising a plurality of pairs of scan electrodes and sustain electrodes configured to generate a display discharge, each pair including a scan electrode and a sustain electrode;
circuit boards, located on a second surface of the chassis base, configured to drive the plasma display panel, wherein the second surface opposes the first surface; at least one sustain electrode driving cable having a first end and a second end, wherein the first end is electrically coupled to the plasma display panel; and
a fixing member configured to fix the second end of the driving cable to the bent portion so as to ground the second end of the driving cable

13. The plasma display module of claim 12, wherein the fixing member is a clip which presses the second end down on the bent portion and grounds the second end to the bent portion.

14. The plasma display module of claim 13, wherein the second end of the driving cable is located to surround at least one portion of the bent portion, and the clip is forcibly fit on the bent portion with the second end interposed between the clip and the bent portion.

15. The plasma display module of claim 13, wherein the clip comprises:
two sidewalls separated from each other having an aperture with a predetermined width through which the chassis base enters between the two sidewalls; and
a coupling portion coupling the sidewalls to each other so that the sidewalls can be elastically biased in directions facing each other.

16. The plasma display module of claim 15, further comprising pressing protrusions extending from the sidewalls toward the chassis base and contacting the chassis base or the driving cable with a predetermined pressure.

17. A plasma display module, comprising:
a chassis base configured to support a plasma display panel;
at least one driving cable, having first and second ends, wherein the first end is electrically connected to the plasma display panel, and wherein the second end is grounded via a portion of the chassis base; and
means for fixing the second end to the portion of the chassis base.

18. The plasma display module of claim 17, wherein the chassis base includes a bent portion, and wherein the fixing means is a clip which presses the second end down on the bent portion and grounds the second end to the bent portion.

19. The plasma display module of claim 17, wherein the at least one driving cable is a sustain electrode driving cable.

20. The plasma display module of claim 19, further comprising a circuit board configured to apply a positive sustain discharge voltage and a negative sustain discharge to scan electrodes.
